(19) United States
(12) Patent Application Publication
(10) Pub. No.: US 2018/0365738 A1
(43) Pub. Date: Dec. 20, 2018

(54) EVALUATING INFLUENCE TO IDENTIFY INDIRECT CONTENT INTERACTIONS

(71) Applicant: Facebook, Inc., Menlo Park, CA (US)

(72) Inventors: Sung-eok Jeon, Bellevue, WA (US); Aliasgar Mumtaz Husain, Milpitas, CA (US)

(21) Appl. No.: 15/627,420

(22) Filed: Jun. 19, 2017

(51) Int. Cl. G06Q 30/02; G06Q 50/00

(52) U.S. Cl. CPC G06Q 30/0271; G06Q 30/0255; G06Q 50/01; G06Q 30/0277; G06Q 30/0252

(57) ABSTRACT

An online system includes a method for selecting influential users of the online system to be presented with content items. The online system receives input from a third party system specifying the type of users that the content items should be presented to. Based on this input, the online system identifies one or more subject users of the online system as candidates to present the content items to. By comparing the actions of a subject user with the actions of one or more users of the online system determined to be closely correlated with the subject user, the online system determines the expected influence of the subject users. The influence of the subject users is used to determine which users to present the content item to.

### BACKGROUND

This disclosure generally relates to evaluating users of an online system for presenting content items to. Specifically, this disclosure relates to evaluating users of an online system for presenting content items to, based on an influence of the users with respect to other users of the online system.

In general, a content item is intended to persuade individuals that view the content item to engage in a desired behavior related to the content item. An individual that views a given content item may not only be persuaded to engage in the desired behavior themselves, but the individual may also indirectly persuade additional individuals to engage in the desired behavior. In this way, by presenting a content item to a single individual, other individuals may fulfill behavioral objectives associated with the content item without even viewing the content item themselves.

Evaluating the possible effect that one individual has on other individuals can be a challenge. Thus, content items are typically presented to individuals with no regard for the probability that these individuals will persuade additional individuals to engage in behavioral objectives associated with the content items.

### SUMMARY

This disclosure describes a method for selecting users of an online system to be presented with content items, based on the expected influence of users on other users' behavior. First, a third party system places a request with the online system to present a given content item to users of the online system. The request may include targeting criteria used in selecting users to present with the content item. Users of the online system that fulfill the specified targeting criteria are selected as subject users. Subject users may be presented with the content item based in part on the expected influence of the subject user with respect to other users. Specifically, if a subject user that fulfills the specified targeting criteria is determined to have a threshold expected influence with respect to other users, the subject user may be presented with the content item.

To determine an expected influence of a subject user with respect to other users, the online system further uses the targeting criteria specified by the third party system to identify a set of connections of the identified subject user. The set of connections of the identified subject user consists of additional users of the online system that have a threshold “affinity” to the subject user. Affinities between users of the online system can be determined by comparing the behaviors of the given users. Generally, users that have a relatively high affinity to one another frequently interact and/or engage similar behaviors.

Next, based on the targeting criteria specified by the third party system, an event coordination score between the subject user and each individual in the subject user's set of connections is determined. An event coordination score is a quantitative measure of the affinity between the subject user and an individual in the subject user's set of connections. Specifically, an event coordination score is a quantitative measure of the synchronization of one or more actions performed by the subject user and the individual in the subject user's set of connections. By comparing the similarity of actions between the two users, an event coordination score measures the influence that the subject user and the connection of the given subject user have on one another. The event coordination score may represent a co-occurrence of actions without respect to timing, or may represent a directional event occurrence, indicating when a user performed an action before another user.

Event coordination scores between the subject user and each individual in the subject user's set of connections are used to determine an influence score for the subject user. An influence score is a measure of the influence that a given subject user has over the actions of all individuals within the given subject user's set of connections.

Based on the subject user's influence score and additional targeting criteria specified by the third party system, the online system determines whether the given subject user is considered to be an influential subject user. Subject users determined to be influential subject users may be presented with content items provided by the third party system.

In alternative embodiments, influence scores for subject users may also be used to rank subject users. These rankings can in turn be used to select subject users to present with content. In further embodiments, a subject user's influence score may be used to assign an expected value of presenting a content item to that subject user. Such expected values can in turn be used in advertising auctions to determine bid amounts or to determine a set of content items to present to the subject user.

By identifying and presenting content items to influential users, the influential users can be persuaded to engage in desired behavior encouraged by the content items. These influential users may then use their influence to persuade additional individuals to engage in the desired behavior associated with the content items. In this manner, a large number of individuals can be indirectly persuaded to engage in desired behavior related to a content item without ever viewing the content item itself. Furthermore, effectively identifying influential users enables better evaluation of the downstream value of presenting content to these users.

### BRIEF DESCRIPTION OF THE DRAWINGS

FIG. 1 is a block diagram of a system environment in which an online system operates, in accordance with an embodiment.

FIG. 2 is a block diagram of an online system that enables indirect conversions, in accordance with an embodiment.

FIG. 3 is a block diagram of a module of an online system that enables indirect conversions, in accordance with an embodiment.

FIG. 4 is a flow chart of a method for targeting users of an online system with an advertisement, in accordance with an embodiment.

FIG. 5 illustrates the determination of a subject user's non-directional influence score, in accordance with an embodiment.

FIG. 6 illustrates the determination of a subject user's directional influence score, in accordance with an embodiment.

FIG. 7 illustrates the determination of a subject user's extended directional influence score, in accordance with an embodiment.

FIG. 8A is a data chart indicating event occurrence within a group of users, in accordance with an embodiment.

FIG. 8B is a data chart of non-directional event coordination scores for a group of users, in accordance with an embodiment.

FIG. 8C is a data chart of non-directional influence scores for a group of users, in accordance with an embodiment.

FIG. 9A is a data chart indicating an ordering of event occurrence within a group of users, in accordance with an embodiment.

FIG. 9B is a data chart of directional event coordination scores for a group of users, in accordance with an embodiment.

FIG. 9C is a data chart of directional influence scores for a group of users, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

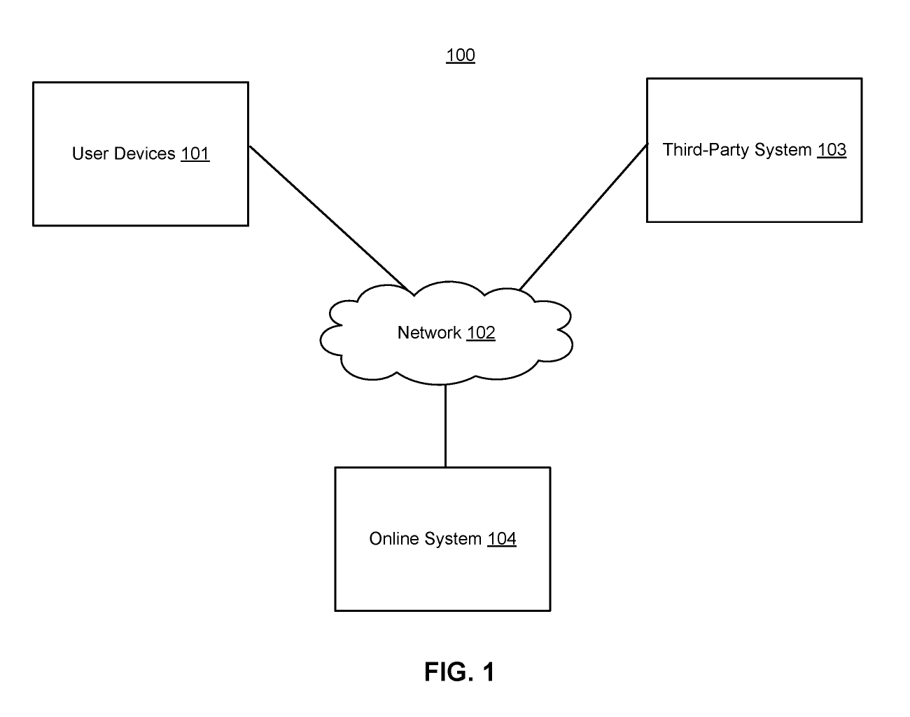

FIG. 1 is a block diagram of a system environment 100 for an online system 104, in accordance with an embodiment. The system environment 100 shown by FIG. 1 comprises one or more user devices 101, a network 102, one or more third party systems 103, and the online system 104. In alternative configurations, different and/or additional components may be included in the system environment 100. In one embodiment, the online system 104 is a social networking system, a content sharing network, or another system providing content to users.

The user devices 101 are one or more computing devices capable of receiving user input as well as transmitting and/or receiving data via the network 102. In one embodiment, a user device 101 is a conventional computer system, such as a desktop or a laptop computer. Alternatively, a user device 101 may be a device having computer functionality, such as a personal digital assistant (PDA), a mobile telephone, a smartphone, or another suitable device. A user device 101 is configured to communicate via the network 102. In one embodiment, a user device 101 executes an application allowing a user of the user device 101 to interact with the online system 104. For example, a user device 101 executes a browser application to enable interaction between the user device 101 and the online system 104 via the network 102. In another embodiment, a user device 101 interacts with the online system 104 through an application programming interface (API) running on a native operating system of the user device 101, such as IOS® or ANDROID™.

The user devices 101 are configured to communicate via the network 102, which may comprise any combination of local area and/or wide area networks, using both wired and/or wireless communication systems. In one embodiment, the network 102 uses standard communications technologies and/or protocols. For example, the network 102 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 102 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 102 may be represented using any suitable format, such as hypertext markup language (HTML) or extensible markup language (XML). In some embodiments, all or some of the communication links of the network 102 may be encrypted using any suitable technique or techniques.

One or more third party systems 103 may be coupled to the network 102 for communicating with the online system 104. In one embodiment, a third party system 103 provides content items to the online system 104 for presentation to users of the online system 104. Content items provided by the third party system 103 system may include sponsored content and content campaigns.

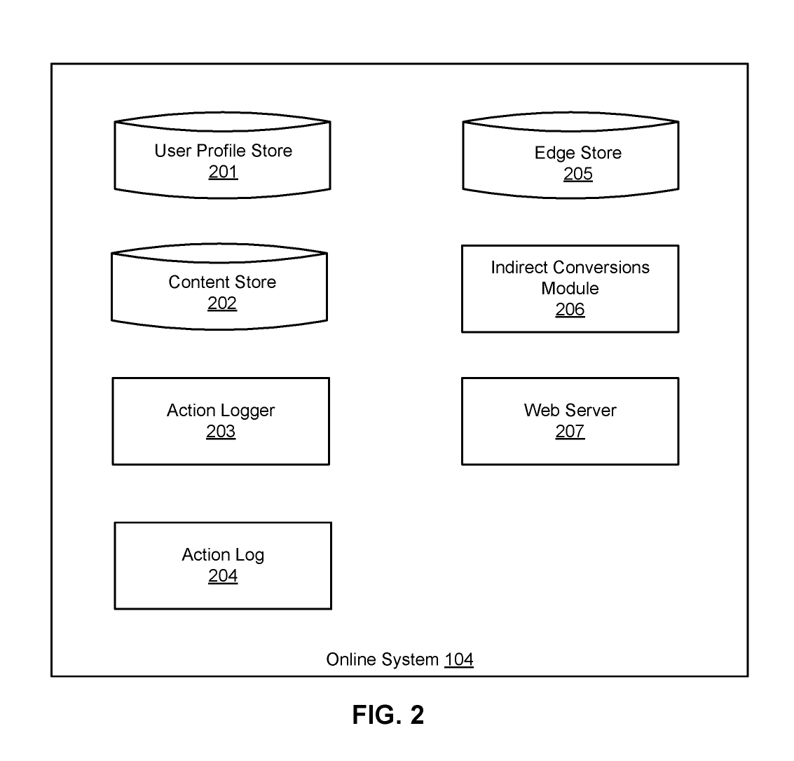

FIG. 2 is a block diagram of the online system 104, in accordance with an embodiment. The online system 104 shown in FIG. 2 includes a user profile store 201, a content store 202, an action logger 203, an action log 204, an edge store 205, an indirect conversions module 206, and a web server 207. In other embodiments, the online system 104 may include additional, fewer, or different components for various applications. Conventional components such as network interfaces, security functions, load balancers, failover servers, management and network operations consoles, and the like are not shown so as to not obscure the details of the system architecture.

Each user of the online system 104 is associated with a user profile, which is stored in the user profile store 201. A user profile includes declarative information about the user that was explicitly shared by the user and may also include profile information inferred by the online system 104. In one embodiment, a user profile includes multiple data fields, each describing one or more attributes of the corresponding online system 104 user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 201 may also maintain references to actions by the corresponding user performed on content items in the content store 202 and stored in the action log 204. Furthermore, a user profile in the user profile store 201 may also maintain references to actions by the corresponding user performed on third party systems 103 and stored in the action log 204. These references to actions performed on third party systems 103 may be received by the online system 104 directly from the third party systems 103 or through an alternative means of user tracking.

In one embodiment, the third party system 103 uses a tracking pixel or piece of HTML code placed by the third party system 103 on third party system 103 websites to monitor users visiting the websites that have not opted out of tracking. A tracking pixel might be included on various pages, including on a product page describing a product, on a shopping cart page that the user visits upon putting something into a shopping cart, on a checkout page that the user visits to checkout and purchase a product, etc. For example, a tracking pixel results in a transparent 1×1 image, an iframe, or other suitable object being created for third party system 103 pages. When a user's browser loads a page having the tracking pixel, the tracking pixel results in the user's browser attempting to retrieve the content for that pixel, and the browser contacts the online system 104 to retrieve the content. The request sent to the online system 104, however, actually includes various data about the user's actions taken on the third party system 103 website. The third party system 103 website can control what data is sent to the online system 104. For example, the third party system 103 may include information about the page the user is loading (e.g., is it a product page, a shopping cart page, a checkout page, etc.), about information on the page or about a product on the page of interest to the user (e.g., the SKU number of the product, the color, the size, the style, the current price, any discounts offered, the number of products requested, etc.), about the user (e.g., the third party system 103's user identifier (UID) for the user, contact information for the user, etc.), and other data. In some embodiments, a cookie set by the online system 104 can also be retrieved by the online system 104, which can include various data about the user, such as the online system 104s' UID for the user, information about the client device and the browser, such as the Internet Protocol (IP) address of the client device, among other data. Tracking can also be performed on mobile applications of content providers by using a software development kit (SDK) of the online system 104 or via an application programming interface (API) of the online system 104 to track events (e.g., purchases) that occur by users on the content provider's app that are reported to the online system 104.

The online system 104 can then use this data received about the user to serve better content to the user in the future (e.g., since the online system 104 has further data about products purchased or browsed that might be of interest), and can also use this in retargeting of that product to the user (e.g., where the user went to the product page on the third party system site by clicking on an of the third party system 103 presented to the user in the online system 104). The online system 104 can also use this data in conversion tracking and reporting results of advertising campaigns to the third party system 103. For example, if the third party system 103 has spent money at the online system 104 to have the online system 104 serve ads for its products, and a particular user views an ad on the online system 104 and then purchases the product advertised (possibly at some point later, and possibly on a different device), the online system 104 can link the purchase/conversion to the ad originally shown on the online system 104. Thus, the online system 104 can include this data in its reporting to the third party system 103 of how many conversions the ad campaign received.

While user profiles in the user profile store 201 are frequently associated with individuals, allowing individuals to interact with each other via the online system 104, user profiles may also be stored for entities such as businesses or organizations. This allows an entity to establish a presence on the online system 104 for connecting and exchanging content with other online system users. The entity may post information about itself, about its products or provide other information to users of the online system 104 using a brand page associated with the entity's user profile. Other users of the online system 104 may connect to the brand page to receive information posted to the brand page or to receive information from the brand page. A user profile associated with the brand page may include information about the entity itself, providing users with background or informational data about the entity.

The content store 202 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 202, such as status updates, photos tagged by users to be associated with other objects in the online system 104, events, groups or applications. In some embodiments, objects are received from third party systems 103 separate from the online system 104. In one embodiment, objects in the content store 202 represent single pieces of content, or content “items.” Hence, online system users are encouraged to communicate with each other by posting text and content items of various types of media to the online system 104 through various communication channels. This increases the amount of interaction of users with each other and increases the frequency with which users interact within the online system 104.

One or more content items included in the content store 202 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 104 if content in the content item is presented to a user, if the content in the content item receives a user interaction when presented, or if any suitable condition is satisfied when content in the content item is presented to a user. For example, the bid amount included in a content item specifies a monetary amount that the online system 104 receives from a user who provided the content item to the online system 104 if content in the content item is displayed. In some embodiments, the expected value to the online system 104 of presenting the content from the content item may be determined by multiplying the bid amount by a probability of the content of the content item being accessed by a user.

In various embodiments, a content item includes various components capable of being identified and retrieved by the online system 104. Example components of a content item include: a title, text data, image data, audio data, video data, a landing page, a user associated with the content item, or any other suitable information. The online system 104 may retrieve one or more specific components of a content item for presentation in some embodiments. For example, the online system 104 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 104 logs interactions between users presented with the content item or with objects associated with the content item. Additionally, the online system 104 receives compensation from a user associated with content item as online system users perform interactions with a content item that satisfy the objective included in the content item.

A content item may include one or more targeting criteria specified by the user who provided the content item to the online system 104. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

The principle embodiment discussed throughout this disclosure is evaluation of users of the online system 104 for presentation with content items from the content store 202. As described above, content items of the content store 202 may include targeting criteria. These targeting criteria may be used in evaluating users of the online system 104 for presentation with content items. Users of the online system 104 that fulfill the specified targeting criteria are selected as subject users. Subject users may be presented with the content item based in part on the expected influence of the subject user with respect to other users of the online system 104.

Influence of a subject user on other users of the online system 104 may be determined based on actions or types of connections between the subject user and other users of the online system 104. A subject user's influence may be determined based on interactions between the subject user and other users performed external to the online system 104, such as on a third party system 103. For example, the influence of a subject user may be determined based on actions performed by that subject user with regard to other users, such as sent a message to another user, used an application, joined a group, left a group, joined an event, generated an event description, purchased or reviewed a product or service using an online marketplace, requested information from a third party system 103, installed an application, or performed any other suitable action. Determining influence of subject users allows users to further refine which subject users are eligible to be presented with content items. As another example, determination of a subject user's influence may include identification of the subject user's connections to another user or object or having a particular type of connection to another user or object. Based on the determined influence of a subject user, the subject user may be presented with content items from the content store 202.

In various embodiments, the content store 202 includes multiple campaigns, which each include one or more content items. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 104 provides the online system 104 with various campaigns each including content items having different characteristics (e.g., associated with different content, including different types of content for presentation), and the campaigns are stored in the content store.

The action logger 203 receives communications about user actions internal to and/or external to the online system 104, populating the action log 204 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 204.

The action log 204 may be used by the online system 104 to track user actions on the online system 104, as well as actions on third party systems 103 that communicate information to the online system 104. Users may interact with various objects on the online system 104, and information describing these interactions is stored in the action log 204. Examples of interactions with objects include: commenting on posts, sharing links, checking-in to physical locations via a user device 101, accessing content items, and any other suitable interactions. Additional examples of interactions with objects on the online system 104 that are included in the action log 204 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 204 may record a user's interactions with advertisements on the online system 104 as well as with other applications operating on the online system 104. In some embodiments, data from the action log 204 is used to infer interests or preferences of a user, augmenting the interests included in the user's user profile and allowing a more complete understanding of user preferences.

The action log 204 may also store user actions taken on a third party system 103, such as an external website, and communicated to the online system 104. For example, an e-commerce website may recognize a user of an online system 104 through a social plug-in enabling the e-commerce website to identify the user of the online system 104. Because users of the online system 104 are uniquely identifiable, e-commerce websites, such as in the preceding example, may communicate information about a user's actions outside of the online system 104 to the online system 104 for association with the user. Hence, the action log 204 may record information about actions users perform on a third party system 103, including webpage viewing histories, advertisements that were engaged, purchases made, and other patterns from shopping and buying. Additionally, actions a user performs via an application associated with a third party system 103 and executing on a user device 101 may be communicated to the action logger 203 by the application for recordation and association with the user in the action log 204.

In one embodiment, the edge store 205 stores information describing connections between users and other objects on the online system 104 as edges. Some edges may be defined by users, allowing users to specify their relationships with other users. For example, users may generate edges with other users that parallel the users' real-life relationships, such as connections, co-workers, partners, and so forth. Other edges are generated when users interact with objects in the online system 104, such as expressing interest in a page on the online system 104, sharing a link with other users of the online system 104, and commenting on posts made by other users of the online system 104.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 104, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 205 also stores information about edges, such as affinity scores for objects, interests, and other users. Affinity scores, or “affinities,” may be computed by the online system 104 over time to approximate a user's interest in an object or in another user in the online system 104 based on the actions performed by the user. A user's affinity may be computed by the online system 104 over time to approximate the user's interest in an object, in a topic, or in another user in the online system 104 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 205, in one embodiment. Alternatively, each interaction between a user and a specific object is stored as a separate edge. In some embodiments, connections between users may be stored in the user profile store 201, or the user profile store 201 may access the edge store 205 to determine connections between users.

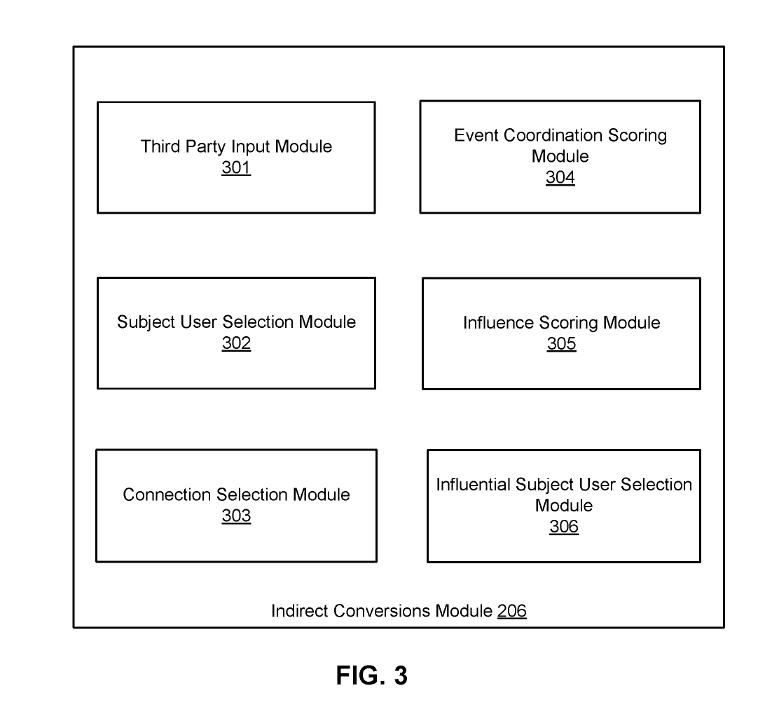

The indirect conversions module 206 evaluates users of the online system 104 to target with content items for a campaign based on their level of influence with respect to other users of the online system 104. The influence of one user for one or more additional users is determined using information from the user profile store 201, the content store 202, the action log 204, and the edge store 205. One embodiment of the indirect conversions module is discussed in greater detail with regard to FIG. 3.

The web server 207 links the online system 104 via the network 102 to the one or more user devices 101, as well as to the one or more third party systems 103. The web server 207 serves web pages, as well as other content, such as JAVA®, FLASH®, XML and so forth. The web server 207 may receive and route messages between the online system 104 and the user device 101, for example, instant messages, queued messages (e.g., email), text messages, short message service (SMS) messages, or messages sent using any other suitable messaging technique. A user may send a request to the web server 207 to upload information (e.g., images or videos) that are stored in the content store 202. Additionally, the web server 207 may provide application programming interface (API) functionality to send data directly to native client device operating systems, such as IOS®, ANDROID™, or BlackberryOS.

FIG. 3 is a block diagram of the indirect conversions module 206, in accordance with an embodiment. The indirect conversions module 206 shown in FIG. 3 includes a third party input module 301, a subject user selection module 302, a connection selection module 303, an event coordination scoring module 304, an influence scoring module 305, and an influential subject user selection module 306.

The third party input module 301 receives a request from a third party system 103 to present a content item to one or more users of the online system 104. As discussed above with regard to FIG. 2, a content request received from a third party system 103 includes a content item, and may also include a bid amount and an objective identifying an interaction that the third party system 103 associated with the content item desires users to perform when presented with the content item. In some embodiments, the content request also includes targeting criteria that may be used in selecting one or more users to whom the content item is presented. Examples of such criteria will be described in further detail with regard to the remaining components of FIG. 3.

The subject user selection module 302 identifies one or more users of the online system 104 as candidates to be targeted with the content specified by a content request. In one embodiment, the subject user selection module 302 uses targeting criteria specified for the content campaign by the third party system 103 when selecting candidates to receive content. These users may be considered as recipients of a content item. The candidates chosen for content targeting by the subject user selection module 302 are referred to as “subject users.” A subject user is a candidate for content targeting. In other words, a subject user may or may not ultimately be presented with a given content. Selection of the subject users that will ultimately be presented with a given content may be determined based on the influence score of a subject user and other factors affecting the expected value of presenting the content item to the subject user.

As one example, a third party system 103 that sells running shoes places a content request with the online system 104. The content request indicates that the content presented to users of the online system 104 should be an image of running shoes. The content request further specifies targeting criteria indicating that users to which the content is presented must engage with content related to running at least three times per month. To determine which users satisfy this targeting criterion, the subject user selection module 302 draws on information from one or more of the user profile store 201, the content store 202, the action log 204, and the edge store 205. For example, the subject user selection module 302 may search for users within the user profile store 201 that have listed running in the user profile data field labeled “hobbies.” The subject user selection module 302 may also identify subject users by searching the content store 202 for photos of users wearing running shoes. The subject user selection module 302 may search the action log 204 to identify users that have indicated they will attend a local marathon. The subject user selection module 302 may also search the edge store 205 to identify users that have “liked” the user profile of an Olympic runner. Through these embodiments as well as others, the subject user selection module 302 can identify subject users that satisfy the targeting criteria specified by the third party system 103.

In some embodiments, subject users may be selected based on data that fulfills targeting criteria specified by the third party system 103, but that was not sourced from the online system 104. In other words, data used in the selection of subject users may be stored and detected on third party systems 103 and then transmitted to the online system 104 for use in selecting subject users. For example, as mentioned with regard to FIG. 1, a third party system 103 may use a tracking pixel or piece of HTML code placed by the third party system 103 on third party system 103 websites to monitor users visiting the websites. Data from such third party system 103 tracking may then be used by the subject user selection module 302 in selecting subject users.

Selection of a subject user may be dependent upon the type of conversion event. In one embodiment, a given user of the online system 104 may not be chosen as a subject user if the user has already engaged with the same or similar a content item in the desired manner. In another embodiment, users that performed conversion actions for high-end, expensive purchases may be excluded in the targeting criteria for content items similar or related to these purchases. This may hold true even if the similar or related content items are sponsored by a third party system 103 other than the third party system 103 providing the campaign. For example, if the content item specified by the third party system 103 is airline tickets to Tahiti, targeting criteria for the airlines tickets may exclude users that have already purchased airline tickets to Tahiti. In an alternative embodiment in which sponsored content items are less expensive, more common items, subject user targeting criteria may not adhere to such limitations. For example, if the content item specified by the third party system 103 is a tin of cookies, a user that has purchased cookies in the past may still be selected as a subject user. In a further embodiment, a frequency of expected purchases may be used to determine the allotted time period between user purchase of an item and selection of the user as a subject user for receipt of content related to the item. For example, a relatively inexpensive, common item such as a T-shirt may be associated with a high frequency of expected purchase. Thus a user that purchased a T-shirt may be selected as a subject user for receipt of a T-shirt content immediately following the purchase of the given shirt. On the other hand, a relatively expensive, enduring, and exclusive item such as a wedding ring may be associated with a lower frequency of expected purchase. Thus a person that purchased a wedding ring may not be chosen as a subject user for receipt of a wedding ring content.

Following identification of a subject user by the subject user selection module 302, the connection selection module 303 identifies one or more additional users of the online system 104 to be used in evaluating the influence of the subject user. The one or more additional users used in evaluating the influence for a subject user are known as a “set of connections” for the given subject user. To improve the accuracy of influence score calculation for a subject user, the set of connections for a subject user are users of the online system 104 with whom the subject user has a strong affinity.

To determine the set of connections for a subject user, the connection selection module 303 may use one or more targeting criteria that must be fulfilled for a user to be considered a connection of the given subject user. In one embodiment, criteria for selecting connections of a subject user are specified by the third party system 103 via the third party input module 301. In another embodiment, the connection selection module 303 specifies standard, pre-determined criteria for selecting connections of a subject user. In yet another embodiment, the online system 104 may suggest criteria for selecting connections for a subject user based on data from previous content campaigns.

For example, a user may be deemed a connection of a subject user if the user and the subject user engage in at least one interaction per day via the online system 104. In another example, a user may be deemed to be a connection of a subject user if the user and the subject user are listed as friends within the online system 104. In another example, a user may be deemed to be a connection of a subject user if the user and the subject user engage in the same behaviors within a specified range of time or within a specified range of geographic location.

Another example of criteria used in the selection of connections for a subject user is directionality of relationship. A relationship between two users may be unidirectional or bidirectional. In other words, user A may have an affinity to user B without existence of reciprocated affinity, user B may have an affinity to user A without existence of reciprocated affinity, or a level of affinity may be reciprocal between both user A and user B. In one embodiment, a third party system 103 may indicate a required directionality of relationship between a user and a given subject user for the user to be considered a connection of the given subject user.

To determine whether a given user fulfills the criteria required to be considered a connection of a given subject user, the connection selection module 303 may draw on information from one or more of the user profile store 201, the content store 202, the action log 204, and the edge store 205. For example, to determine whether a user and a subject user engaged in the same behavior within a specified range of time, the connection selection module 303 may conduct a search within the action log 204. In another example, the connection selection module 303 may use affinity scores stored in the edge store 205 to determine whether or not a user is a connection of a given subject user.

In some embodiments, connections of a subject user may be selected based on data that fulfills criteria specified by the third party system 103, but that was not sourced from the online system 104. For example, fulfillment of criteria may be detected by the online system 104 based on activity tracked external to the online system 104.

Finally, a connection can be quantitatively scored based on fulfillment of targeting criteria such as the targeting criteria described above. Using the scores calculated for all connections of a subject user, the connections can be ranked. The final set of connections for the subject user can be selected from this ranked list of connections. For example, in some embodiments, all connections with at least a specified threshold score are included in the subject user's set of connections. In another embodiment, a specified number of connections with the highest scores are included in the subject user's set of connections.

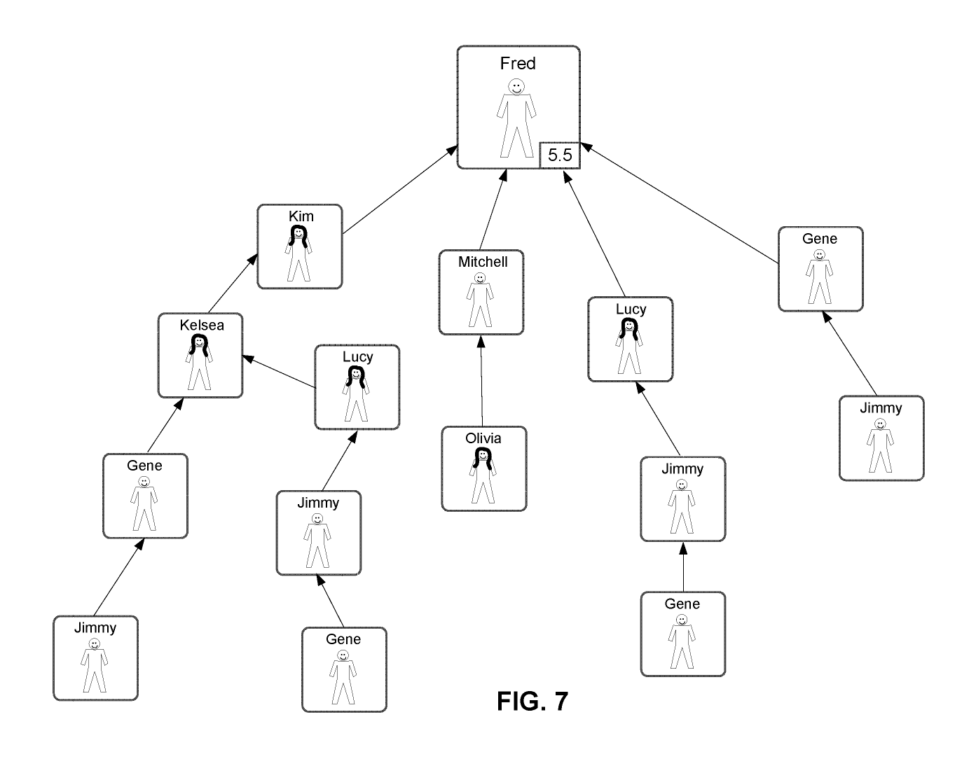

In some embodiments, a set of connections of a subject user may include users with whom the subject user has no direct relationship, but with whom another user within the subject user's set of connections has a direct relationship, thereby creating an indirect, extended relationship between the subject user and a connection of the subject user's connection. The subject user's set of connections therefore may include users with a number of degrees of separation from the subject user. Accordingly, though not directly connected to the subject user, these indirectly-connected users may be more likely to be influenced by the subject user's action than a directly connected user that is not closely-connected to the subject user. Criteria input by the third party system 103 via the third party input module 301 may regulate the inclusion of indirect connections within a subject user's set of connections. An example of this embodiment is described in more detail with regard to FIG. 7.

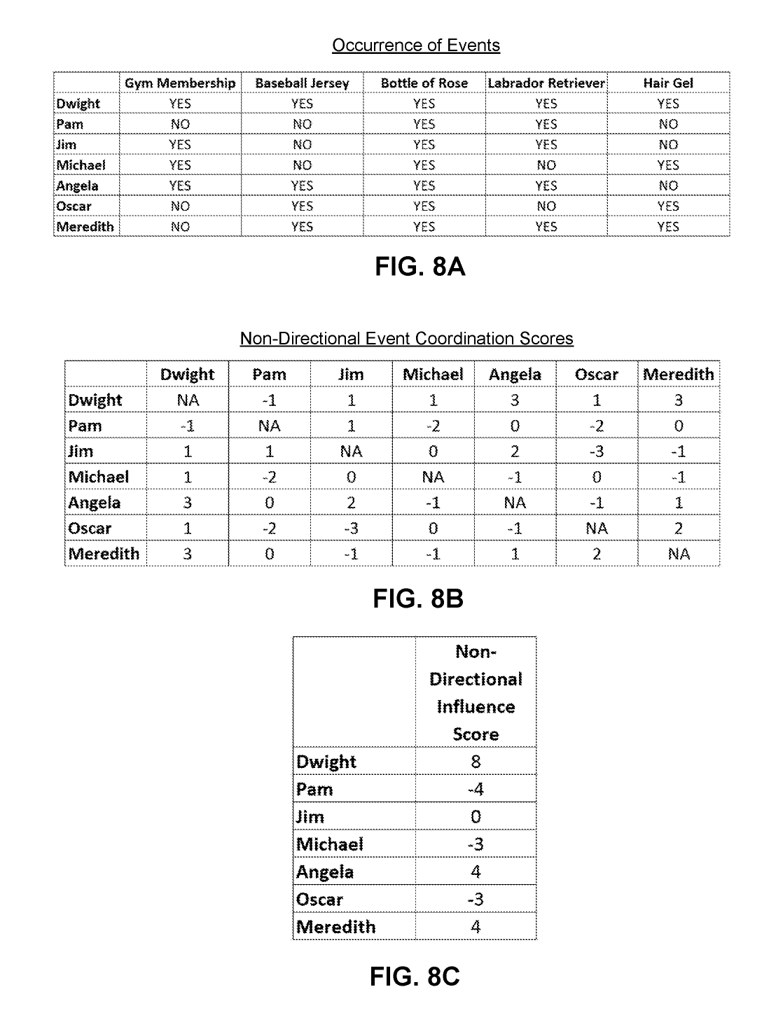

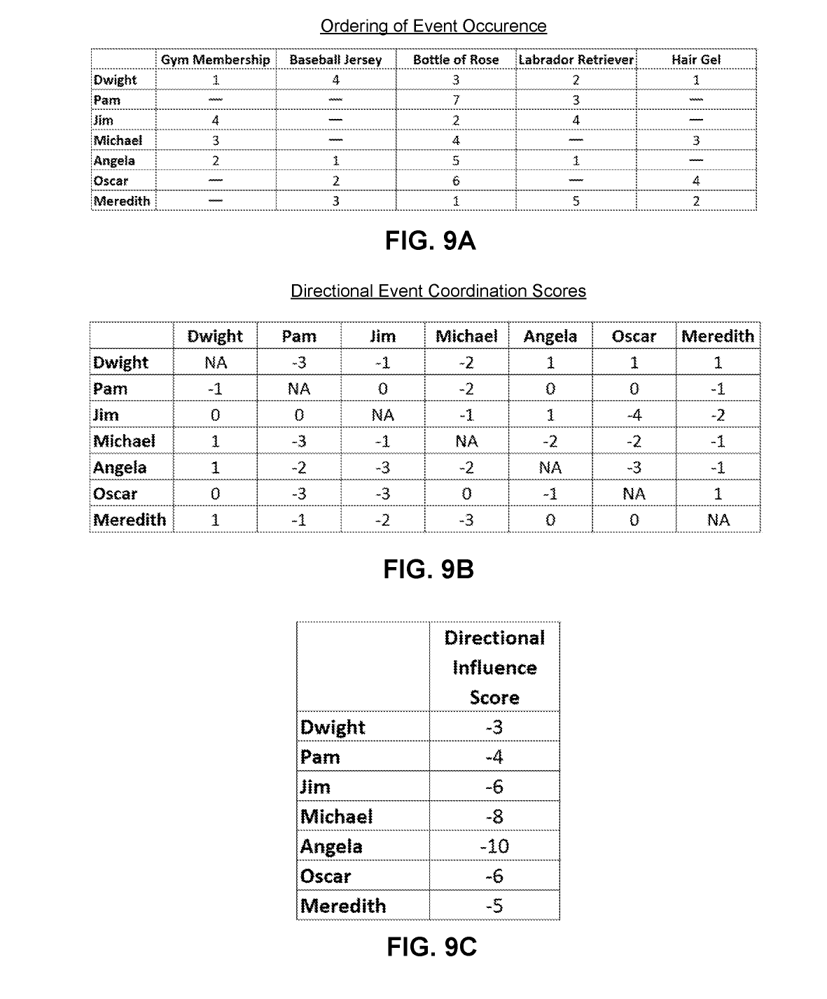

The connection selection module 303 may also identify a group of users not based on a connection to a subject user, but based on the qualities of the group itself. For example, an advertiser selling swim caps may wish to identify the most influential member of a swim team expecting that user to influence other members of the team. In this example, a subject user is not selected initially. Instead, the swim team is initially selected as a set of connections, and each user may be evaluated as a subject user with respect to the group. An example of a similar embodiment is discussed in further detail with regard to FIGS. 8A, 8B, 8C, 9A, 9B, and 9C.

Turning back to FIG. 3, the event coordination scoring module 304 determines an event coordination score between a subject user and each user within the subject user's set of connections. An event coordination score is a quantitative measure of the coordination or synchronization of one or more actions or events executed by two independent individuals within a certain period of time. By comparing the similarity of actions between individuals, an event coordination score measures how closely the given individuals mimic one another. Thus the event coordination score determined by the event coordination scoring module 304 is a measurement of the influence that a subject user has on a connection.

In one embodiment, actions used in the calculation of event coordination scores are specified by the third party system 103 via the third party input module 301. In another embodiment, the event coordination scoring module 304 specifies actions considered in calculation of event coordination scores. In yet another embodiment, the online system 104 may suggest actions for inclusion based on data from previous cases.

For example, a third party system 103 may indicate that all actions related to the consumption of food be included in the event coordination score calculation. On the other hand, the third party system 103 may specify that the purchase of almond butter be the only action considered in the calculation of event coordination scores. As another example, a third party system 103 may indicate that all social actions should be included in the calculation of event coordination scores. Examples of social actions include “liking” a specific page, listening to a specific song, following a specific celebrity, replying to a specific comment, or sharing a specific post. As another example, a third party system 103 may indicate that all actions considered in calculation of the event coordination score may be more closely tied to advertising. Some examples of actions tied to advertising may be clicking on a specific advertisement, purchasing a specific item, or watching a specific video advertisement.

To determine whether a given user has completed an action used in the calculation of event coordination scores, the event coordination scoring module 304 may use information from one or more of the user profile store 201, the content store 202, the action log 204, and the edge store 205. For example, to determine whether a user and a subject user watched the same advertisement within a specified range of time, the connection selection module 303 may conduct a search within the action log 204.

In some embodiments, actions that do not occur on the online system 104 can be used in the calculation of event coordination scores. For instance, actions used in event coordination score calculation may be executed and detected on third party systems 103 and then transmitted to the online system 104 for inclusion in the calculation. For example, as mentioned with regard to FIG. 1, a third party system 103 may use a tracking pixel or piece of HTML code placed by the third party system 103 on third party system 103 websites to monitor users visiting the websites. Data from such third party system 103 tracking may then be used in the calculation of event coordination scores by the event coordination scoring module 304.

The time period within which one user performs an action previously performed by another user is also relevant in the calculation of the event coordination score between the two users, and may be included in the calculation. In one embodiment, a third party system 103 or the event coordination scoring module 304 may specify a maximum threshold of time required for actions executed by two independent users to be considered in the calculation of their event coordination score. In another embodiment, the event coordination score between two users might be weighted more heavily for users that perform the same action within ten minutes of one another than for a different pair of users that perform the same action within one week of one another. Additional embodiments not explicitly mentioned here are also possible.

An event coordination score can either be non-directional or directional. A non-directional event coordination score does not take into account the order of actions or events executed by the individuals in question. In other words, a non-directional event coordination score does not distinguish between which users are the followers and which users and the influencers. One embodiment of the calculation of non-directional event coordination scores is described in greater detail with regard to FIGS. 8A and 8B.

On the other hand, a directional event coordination score takes into account the order in which individuals in a group perform a given action. Each individual in the group is assigned a unique event coordination score that indicates the degree to which the individual is an influencer or a follower of each additional individual within the given group. This emphasis on directionality enables a more precise determination of which users initiate actions that others also perform. One embodiment of the calculation of directional event coordination scores is explained in more detail with regard to FIGS. 9A and 9B.

The directionality of event coordination scores can be specified by a third party system 103 via the third party input module 301, or by the settings of the event coordination scoring module 304. The event coordination scoring module 304 then evaluates the event coordination scores based on the specified directionality.

The influence scoring module 305 determines an influence score for a given subject user. In the case in which a group of users is selected without regard for a subject user, the influence scoring module 305 determines an influence score for each user within the group of users. An influence score is a measure of the influence that a given individual has over the actions of all individuals in a given group. In the case of a subject user, the subject user's influence score is a measurement of the influence that the subject user has over the actions of all users within the subject user's set of connections. Two embodiments of the calculation of influence scores are shown in FIGS. 8C and 9C. Based on the event coordination scores used in the calculation of influence scores, the influence scores may be either non-directional or directional. Specifically, if non-directional event coordination scores are used in the calculation of an influence score, the influence score will be non-directional. On the other hand, if directional event coordination scores are used in the calculation of an influence score, the influence score will be directional. Based on calculated influence scores, influential subject users can be identified.

The influential subject user selection module 306 identifies influential subject users based on subject users' influence scores calculated by the influence scoring module 305. “Influential subject users” are the subject users that are ultimately chosen to be presented with a given advertisement. The influential subject user selection module 306 uses criteria specified by the third party system 103 via the third party input module 301 or by the influential subject user selection module 306 in the selection of influential subject users. One example of criteria used in the selection of influential subject users may be a threshold influence score. In this example, a subject user may be considered influential only if their influence score is greater than a given value. Another example of criteria used in the selection of influential subject users may be the total number of influential subject users desired.

In alternative embodiments, influence scores for subject users may also be used to rank subject users. These rankings can in turn be used to select subject users to present with content. In further embodiments, a subject user's influence score may be used to assign an expected value of presenting a content item to that subject user. Such expected values can in turn be used in advertising auctions to determine bid amounts or to determine a set of content items to present to the subject user.

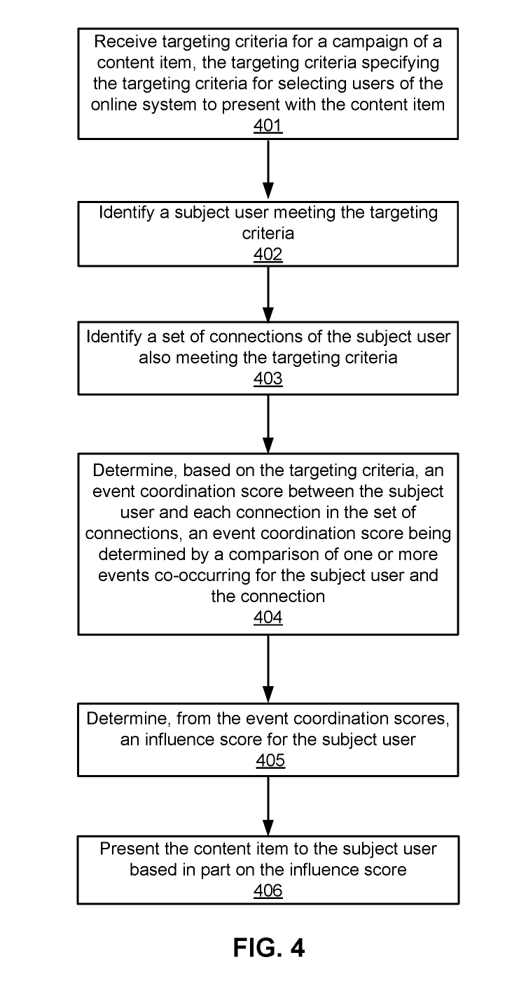

FIG. 4 is a flow chart of a method for targeting users of the online system 104 with an advertisement, in accordance with an embodiment. In other embodiments, the method may include different and/or additional steps than those shown in FIG. 4. Additionally, steps of the method may be performed in different orders than the order described in conjunction with FIG. 4 in various embodiments.

The online system 104 receives 401 targeting criteria for a campaign of a content item, the targeting criteria specifying the targeting criteria for selecting users of the online system 104 to present with the content item. The targeting criteria received may apply to numerous steps of the targeting process.

The online system 104 identifies 402 a subject user meeting the targeting criteria specified by the content campaign in step 401. The identified subject user is a candidate for content targeting. In other words, the subject user may or may not ultimately be presented with the content item introduced in step 401. Selection of subject users that will ultimately be presented with the content item may be determined based influence scores determined for the subject users, as well as other factors affecting the expected value of presenting the content item to the subject users.

The online system 104 identifies 403 a set of connections of the subject user also meeting the targeting criteria specified in step 401. To improve the accuracy of influence score calculation for the subject user, the set of connections for the subject user may be users of the online system 104 with whom the subject user has a strong affinity.

The online system 104 determines 404, based on the targeting criteria, an event coordination score between the subject user and each connection in the set of connections, an event coordination score being determined by a comparison of one or more events co-occurring for the subject user and the connection. Two embodiments for the calculation of event coordination scores are described in greater detail with regard to FIGS. 8A, 8B, 9A, and 9B.

The online system 104 determines 405, from the event coordination scores, an influence score for the subject user. Two embodiments for the calculation of an influence score are described in greater detail with regard to FIGS. 8C and 9C.

Finally, the online system 104 presents 406 the content item to the subject user based in part on the influence score. Presentation of the content item to the subject user may also depend on the expected value of presenting the content item to the subject user.

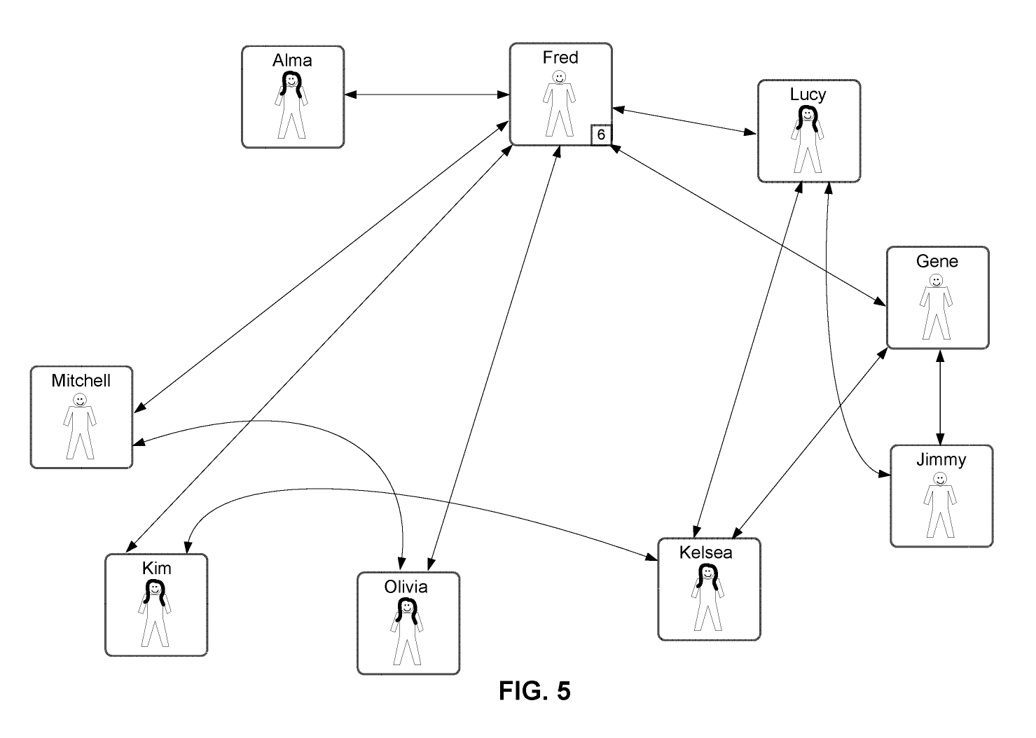

FIG. 5 illustrates the determination of a subject user's non-directional influence score, in accordance with an embodiment. In the embodiment depicted in FIG. 5, each user of the online system 104 is represented by a portrait icon and a name. Fred is the subject user under analysis. Thus FIG. 5 depicts the determination of Fred's non-directional influence score with regard to his set of connections. Fred's set of connections comprises all of the other users depicted in FIG. 5, including Alma, Lucy, Gene, Jimmy, Kelsea, Olivia, Kim, and Mitchell. As noted with regard to FIG. 3, Fred's set of connections may be selected in a plurality of ways. However by selecting users that are closely correlated with Fred for inclusion in his set of connections, Fred's influence score can be more accurately calculated.

In the embodiment depicted in FIG. 5, each arrow indicates a coordination of behavior between the two users that the given arrow connects. In other words, existence of an arrow between two users implies that both users behaved similarly with regard to a given event. Non-existence of an arrow between two users implies that both users behaved differently with regard to a given event. For example, the arrow drawn between Alma and Fred indicates a similar pattern of behavior between Alma and Fred with regard to an event. In this way, each arrow represents an event coordination score between two users. In alternative embodiments, means other than arrows may be used to describe event coordination between users.

The events on which the coordinated event scoring of FIG. 5 is based may be preset by the indirect conversions module 206, or they may be designated by the third party system 103. As described with regard to FIG. 3, any type of events may be chosen for use in the coordinated event scoring. For example, each arrow connecting two users may indicate that both users purchased a snowboard, or that neither user purchased a snowboard. Absence of an arrow may indicate that one user purchased a snowboard, but the other did not.

Additional criteria for event coordination scoring besides event specification may also be provided by the indirect conversions module 206 or by the third party system 103. For example, the third party system 103 may indicate that the purchase of a snowboard is only considered a coordinated event between two users if the two users in question purchase the snowboard within one month of one another. In this case, each arrow connecting two users indicates that both users purchased a snowboard within a one month period of time. Absence of an arrow in this case indicates that one user purchased a snowboard but the other did not, that both users purchased a snowboard but not within a single month, or that neither user purchased a snowboard.

Each arrow of FIG. 5 may represent coordination of behavior with regard to one event, or a plurality of events. For example, in some embodiments an arrow may indicate that two users behaved similarly with regard to at least two of a plurality of events. Furthermore, each arrow of FIG. 5 may represent coordination of behavior with regard to the same event, or with regard to different and unrelated events. For instance, one arrow may indicate that two users both viewed a cat video while another arrow indicates that two users both visited the same ice cream parlor.

Each arrow of FIG. 5 points towards both of the users that the given arrow connects. As a result, an order of events cannot be predicted from the arrows of FIG. 5. In other words, the arrows do not indicate which users are the influencers and which users are the followers. Thus the event coordination scores represented by the arrows are considered non-directional, and each user connected by a given arrow is considered equivalently influential over the other.

To assign a quantitative influence score to the subject user Fred, the embodiment depicted in FIG. 5 has assigned a value of one influence point to each arrow representing a coordinated event. As shown by the arrows connecting Fred to users within his connection group, Fred engages in a coordinated event with six of his eight connections. Specifically, Fred engages in a coordinated event with Alma, Lucy, Gene, Olivia, Mitchell, and Kim. From each coordinated event with each connection, Fred receives one influence point. The use of non-directional event coordination scores in turn produces a non-directional influence score. Thus, Fred has a total non-directional influence score of six. This score is depicted within a box within Fred's user profile. In alternative embodiments of FIG. 5, coordinated events may be scored according to different standards, in turn affecting calculation of a subject user's influence score.

While influence score calculation is performed only for the subject user Fred, arrows depicting event coordination scores between other users have been included for use in FIG. 7. These arrows are described below with regard to the figure.

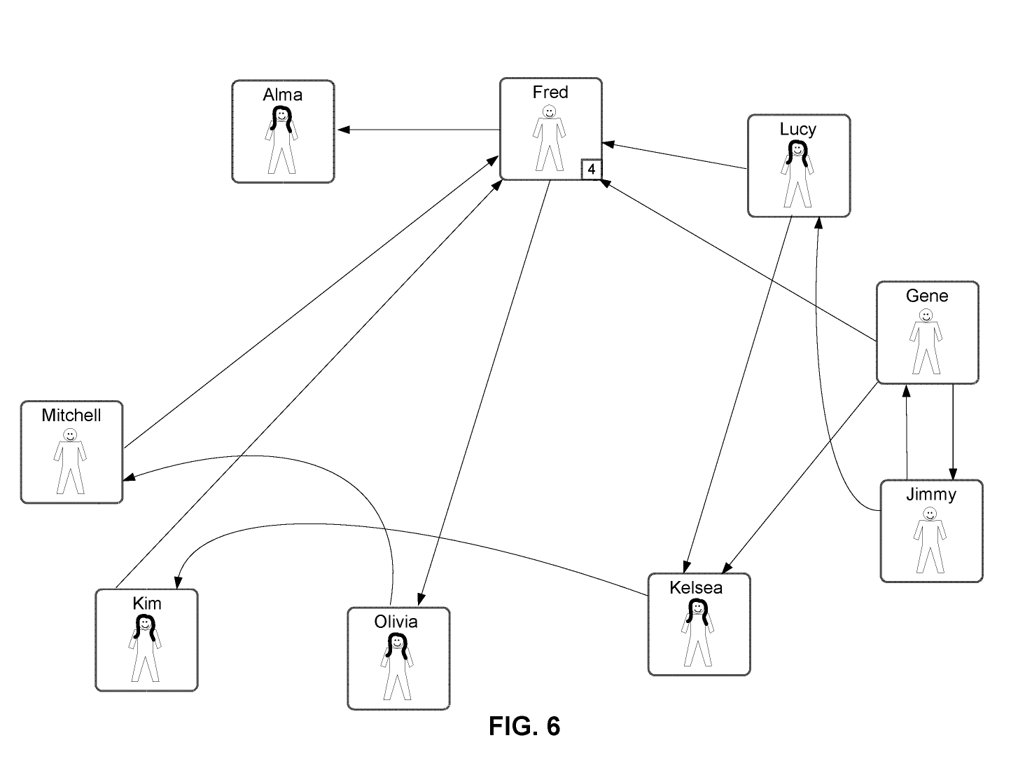

FIG. 6 illustrates the determination of a subject user's directional influence score, in accordance with an embodiment. The example scenario depicted in FIG. 6 is the same as that of FIG. 5 notwithstanding the principle differences attributed to the directionality of the event coordination scoring that is discussed below.

In the embodiment depicted in FIG. 6, each user of the online system 104 is represented by a portrait icon and a name. Fred is the subject user under analysis. Thus FIG. 6 depicts the determination of Fred's directional influence score with regard to his set of connections. Fred's set of connections comprises all of the other users depicted in FIG. 6, including Alma, Lucy, Gene, Jimmy, Kelsea, Olivia, Kim, and Mitchell. As noted with regard to FIG. 3, Fred's set of connections may be selected in a plurality of ways. However by selecting users that are closely correlated with Fred for inclusion in his set of connections, Fred's influence score can be more accurately calculated.

In the embodiment depicted in FIG. 6, each arrow indicates a coordination of behavior between the two users that the given arrow connects. In other words, existence of an arrow between two users implies that both behaved similarly with regard to a given event. Non-existence of an arrow between two users implies that both users behaved differently with regard to a given event. For example, the arrow drawn between Alma and Fred indicates a similar pattern of behavior between Alma and Fred with regard to an event. In this way, each arrow represents an event coordination score between two users. In alternative embodiments, means other than arrows may be used to describe event coordination between users.

The events on which the coordinated event scoring of FIG. 6 is based may be preset by the indirect conversions module 206, or they may be designated by the third party system 103. As described with regard to FIG. 3, any type of events may be chosen for use in the coordinated event scoring. For example, each arrow connecting two users may indicate that both users purchased a snowboard, or that neither user purchased a snowboard. Absence of an arrow may indicate that one user purchased a snowboard, but the other did not.

Additional criteria for event coordination scoring besides event specification may also be provided by the indirect conversions module 206 or by the third party system 103. For example, the third party system 103 may indicate that the purchase of a snowboard is only considered a coordinated event between two users if the two users in question purchase the snowboard within one month of one another. In this case, each arrow connecting two users indicates that both users purchased a snowboard within a one month period of time. Absence of an arrow in this case indicates that one user purchased a snowboard but the other did not, that both users purchased a snowboard but not within a single month, or that neither user purchased a snowboard.

Each arrow of FIG. 6 may represent coordination of behavior with regard to one event, or a plurality of events. For example, in some embodiments an arrow may indicate that two users behaved similarly with regard to at least two of a plurality of events. Furthermore, each arrow of FIG. 6 may represent coordination of behavior with regard to the same event, or with regard to different and unrelated events. For instance, one arrow may indicate that two users both viewed a cat video while another arrow indicates that two users both visited the same ice cream parlor.

Each arrow of FIG. 6 demonstrates an order in which users performed an event by pointing towards one of the users that the given arrow connects. The user at which an arrow points is followed by the user from which the given arrow originates. In other words, an event corresponding to a given arrow is performed by the user at which the arrow points prior to the user from which the arrow originates. Thus the user at which an arrow points is considered the influencer for the given event, and the user from which an arrow originates is considered the follower for the given event. In this way, event coordination scores represented by such arrows are considered directional, and only the user at which an arrow points is considered to be influential with regard to the given event.

To assign a quantitative influence score to the subject user Fred, the embodiment depicted in FIG. 6 has assigned a value of one influence point to each arrow representing a coordinated event. As shown by the arrows connecting Fred to users within his connection group, Fred engages in a coordinated event with six of his eight connections. Specifically, Fred engages in a coordinated event with Alma, Lucy, Gene, Olivia, Mitchell, and Kim. However, of these six coordinated events in which Fred participates, as shown by the directional arrows, he is the influencer of only four of these events. In other words, of the six event instances, Fred performs the given event first in only four of these instances. In two of the instances, Fred performs the given event following another user. Specifically, Fred influences Mitchell, Kim, Gene, and Lucy. On the other hand, Fred is influenced by Alma and Olivia. From each coordinated event that Fred performs prior to his connection, Fred receives one influence point. From each coordinated event that Fred performs after his connection, Fred receives zero influence points. The use of directional event coordination scores in turn produces a directional influence score. Thus, Fred has a total directional influence score of four. This score is depicted within a box within Fred's user profile. In alternative embodiments of FIG. 6, coordinated events may be scored according to different standards, in turn affecting calculation of a subject user's influence score.

While influence score calculation is performed only for the subject user Fred, arrows depicting event coordination scores between other users have been included for use in FIG. 7. These arrows are described below with regard to the figure.

As a result of the use of directional event coordination scoring, the subject user Fred receives a lower overall influence score compared to the same scenario in which non-directional event coordination scoring was used. In this way, use of directional event coordination scoring enables the indirect conversions modules 206 to pare down the number of subject users labeled as influential subject users, which in turn pares down the number of users to which a given advertisement is presented. This results in more efficient advertising because it ensures that the few individuals to whom an advertisement is presented are the most influential.

FIG. 7 illustrates the determination of a subject user's extended directional influence score, in accordance with an embodiment. FIG. 7 is an alternative depiction of the example of directional influence scoring provided in FIG. 6. However, FIG. 7 also includes extended directional influence scoring as discussed below.

Like the example depicted in FIG. 6, each user of the online system 104 is represented by a portrait icon and a name. Fred is the subject user under analysis. However, unlike FIG. 6, not all of the other users depicted in FIG. 7 are necessarily members of Fred's set of connections. The users over which Fred exerts direct influence are members of Fred's set of connections. Thus Gene, Lucy, Kim, and Mitchell are members of Fred's set of connections. These individuals contribute to Fred's influence score in the same manner as is depicted in FIG. 6. Jimmy, Kelsea, and Olivia may be members of Fred's set of connections, or they may be Fred's indirect, extended connections. In other words, Jimmy, Kelsea, and Olivia may be connections of Fred's connections. These individuals may contribute to Fred's influence score in the same manner or in an alternative manner compared to the users within Fred's set of connections.

In the embodiment depicted in FIG. 7, each arrow indicates a coordination of behavior between the two users that a given arrow connects. Existence of an arrow between two users implies that both users behaved similarly with regard to a given event. For example, the arrow drawn between Kim and Fred indicates a similar pattern of behavior between Kim and Fred with regard to an event. In this way, each arrow represents an event coordination score between two users. In alternative embodiments, means other than arrows may be used to describe event coordination between users.

The events on which the coordinated event scoring of FIG. 7 is based may be preset by the indirect conversions module 206, or they may be designated by the third party system 103. As described with regard to FIG. 3, any type of events may be chosen for use in the coordinated event scoring. For example, each arrow connecting two users may indicate that both users purchased a snowboard, or that neither user purchased a snowboard.

Additional criteria for event coordination scoring besides event specification may also be provided by the indirect conversions module 206 or by the third party system 103. For example, the third party system 103 may indicate that the purchase of a snowboard is only considered a coordinated event between two users if the two users in question purchase the snowboard within one month of one another. In this case, each arrow connecting two users indicates that both users purchased a snowboard within a one month period of time.

Each arrow of FIG. 7 may represent coordination of behavior with regard to one event, or a plurality of events. For example, in some embodiments an arrow may indicate that two users behaved similarly with regard to at least two of a plurality of events. Furthermore, each arrow of FIG. 7 may represent coordination of behavior with regard to the same event, or with regard to different and unrelated events. For instance, one arrow may indicate that two users both viewed a cat video while another arrow indicates that two users both visited the same ice cream parlor.

Each arrow of FIG. 7 demonstrates an order in which users performed an event by pointing towards one of the users that the given arrow connects. The user at which an arrow points is followed by the user from which the given arrow originates. In other words, an event corresponding to a given arrow is performed by the user at which the arrow points prior to the user from which the arrow originates. Thus the user at which an arrow points is considered the influencer for the given event, and the user from which an arrow originates is considered the follower for the given event. In this way, event coordination scores represented by such arrows are considered directional, and only the user at which an arrow points is considered to be influential with regard to the given event.

The embodiment in FIG. 7 depicts all methods in which the subject user Fred may have any direct or non-direct influence on any of the users shown in FIG. 6. As shown in FIG. 7, Fred has direct influence over his connections Kim, Mitchell, Lucy, and Gene. Each of Fred's connections also exerts direct influence over additional users. Specifically, Kim has direct influence over Kelsea, Mitchell has direct influence over Olivia, Lucy has direct influence over Jimmy, and Gene also has direct influence over Jimmy. The secondary users over which Fred's connections have direct influence may or may not be members of Fred's set of connections. However, Fred indirectly exerts some level of influence over these secondary users via his influence over the users that the secondary users are influenced by. For example, Fred influences Mitchell, who in turn influences Olivia. By influencing Mitchell's decisions, Fred is indirectly influencing Olivia's decisions because Olivia is influenced by Mitchell. Thus to some degree, Fred influences Olivia. In some embodiments, this indirect influence may be included in Fred's extended influence score.

This pattern not only exists for secondary users that are once removed from the influence of subject user Fred, but for users that are removed any plurality of times from Fred's influence. For example, Gene is three times removed from Fred's influence in the following manner: Fred influences Kim, who influences, Lucy, who influences Jimmy, who influences Gene. In this way Gene is indirectly influenced by Fred via a chain of users. In some embodiments, such indirect influence may also be included in Fred's extended influence score.

Gene, Jimmy, and Lucy all appear multiple times within the influence pyramid of FIG. 7. This indicates that the subject user Fred has multiple means or pathways through which he can influence these repeatedly occurring users. For example, Fred not only directly influences Gene, but also indirectly influences Gene via his influence over Kim and Lucy. This repeated influence over a user may also be included in Fred's extended influence score in some embodiments.

To assign a quantitative influence score to the subject user Fred, the embodiment depicted in FIG. 7 has assigned a value of one influence point to each arrow representing a coordinated event. However, for each degree that a user influenced by the subject user Fred is removed from Fred's direct influence, the influence point awarded to the subject user Fred is decreased by 50%. For example, Fred is awarded 0.5 influence points for his influence over Olivia because Olivia is once removed from Fred's direct influence. The same holds true for both Kelsea and Jimmy, who are also once removed from Fred's direct influence.

Furthermore, in the embodiment depicted in FIG. 7, any repeated influence over a given user is not accounted for in the subject user's influence score. Specifically, the subject user's largest influence score over a repeatedly influenced user is included in the subject user's influence score, but any additional influence over the same repeatedly influenced user is not accounted for in the subject user's influence score. For example, Fred exerts influence over Gene via a plurality of pathways. As noted above, Fred not only directly influences Gene, but also indirectly influences Gene via his influence over Kim and Lucy. Because Fred's greatest influence over Gene comes via his direct influence over Gene, this direct influence is accounted for in Fred's influence score. Fred's lesser influence over Gene via his influence over Kim and Lucy is not accounted for in Fred's influence score.

Using these principles specific to the embodiment depicted in FIG. 7, Fred's influence score is calculated in the following manner. As a result of his direct engagement in a coordinated event with Kim, Mitchell, Lucy, and Gene, Fred receives one influence point each. Then, as a result of his once-removed engagement in a coordinated event with Kelsea, Olivia, and Jimmy, Fred receives 0.5 influence points each. Repeated influence over a given user is not accounted for in Fred's influence score. As a result, Fred's overall extended, directional influence score is 5.5. This score is depicted in a box within Fred's user profile.

In alternative embodiments of FIG. 7, coordinated events may be scored according to different standards, in turn affecting calculation of a subject user's influence score. These standards may be specified by the indirect conversions module 206 or by the third party system 103. For example, in alternative embodiments, repeated influence over a given user might be accounted for using an exponential decay function. In another embodiment, the number of users between the subject user and an indirectly influenced user might be limited such that the chain of influence does not continue indefinitely. Finally, while the calculation of a subject user's extended influence score depicted in FIG. 7 is with regard to directional event coordination scoring, the same methods and principles may also apply to non-directional event coordination scoring in alternative embodiments.

As a result of including Fred's indirect influence over distant users in his influence score, Fred received a greater overall influence score compared to the same scenario in which only Fred's direct influence was accounted for. However, Fred's extended, directional influence score still remains lower than his non-directional influence score. In this way, the inclusion of indirect influence in a subject user's influence score enables calculation of a median influence score between the two extremes of purely non-directional and directional influence scores.

FIGS. 8A, 8B, and 8C are meant to accompany one another and depict a method of non-directional influence score calculation for a group of users of the online system 104 in accordance with one embodiment. In other embodiments, non-directional influence score calculation may include different and/or additional steps than those shown in FIGS. 8A, 8B, and 8C. Additionally, steps of the method may be performed in different orders than the order described in conjunction with FIGS. 8A, 8B, and 8C in various embodiments.

FIGS. 8A, 8B, and 8C demonstrate one embodiment of the calculation of non-directional influence scores with regard to a group of users of the online system 104. These users are Dwight, Pam, Jim, Michael, Angela, Oscar, and Meredith. In the embodiment shown in FIGS. 8A, 8B, and 8C, the group of users was not chosen with regard to a central subject user. Rather, the entire group was chosen as a whole with the intent of finding the user that has the greatest influence over all other users of the group. Thus for the purpose of influence score calculations, this group of users is assumed to be a closed connection group. In other words, the set of connections of each individual in the example group is assumed to comprise all of the other individuals within the group, and only those individuals. For example, Dwight's set of connections consists of Pam, Jim, Michael, Angela, Oscar, and Meredith. Angela's set of connections consists of Dwight, Pam, Jim, Michael, Oscar, and Meredith. This pattern continues for all other individuals within the group. As a result, each individual's influence score is calculated with respect to all of the non-self individuals in this single set of connections. Using these influence scores, the most influential individual in the group can be determined.

If this group was selected based on a single subject user and thus was not a closed connection group, only the subject user's influence score could be accurately calculated with regard to the given group. The influence scores of all other users within the group must be calculated with regard to each user's unique set of connections. In a majority of real world applications, connection groups are not closed. In other words, each subject user has a unique set of connections, and thus requires a unique set of connections. However, in some instances, it may be more desirable to find the most influential individual within a set group of individuals as in FIGS. 8A, 8B, and 8C. For example, a company selling cheese might want to find the most influential member within a local cheese lovers club.

FIG. 8A is a data chart indicating event occurrence within the closed connection group mentioned above, in accordance with an embodiment. FIG. 8A lists five unique purchase opportunities. Specifically, each user has the opportunity to purchase or refuse the following items: a gym membership, a baseball jersey, a bottle of rosé, a Labrador retriever, and hair gel. In alternative embodiments, as described with regard to FIG. 3, alternative options may be used in the calculation of influence scores. Each decision of each individual in the group to either purchase or not purchase each of these five items is considered to be an event.

The data chart in FIG. 8A indicates each individual's response to each of the five purchase opportunities. In other words, the data indicates whether each individual purchased or refused each item. ‘YES’ indicates that the corresponding user did purchase the corresponding item. ‘NO’ indicates that the corresponding user did not purchase the corresponding item. This binary, qualitative data does not indicate in an order in which events occurred. It simply indicates whether or not an event took place. As a result, only non-directional event coordination scores and thus non-directional influence scores can be calculated from this data as shown in FIGS. 8B and 8C.

FIG. 8B is a data chart of non-directional event coordination scores for the closed connection group of FIG. 8A, in accordance with an embodiment. Using the event occurrence data of FIG. 8A, a non-directional event coordination score is calculated for each pair of individuals within the closed connection group. Because the occurrence of events is not ordered, the individuals within each pair share the same non-directional event coordination score.

In the embodiment depicted in FIG. 8B, the following standards are used to calculate a non-directional event coordination score for a pair of users A and B. The initial event coordination score for users A and B is set to a value of 0, indicating no event coordination. For each purchase event listed, the actions of users A and B are compared. If both users A and B did purchase the same item, one point is added to their event coordination score. If one user purchased the item, but the other user did not purchase the item, one point is subtracted from their event coordination score. If both users A and B did not purchase the item, their event coordination score is unaffected. A relatively positive event coordination score between two users indicates some degree of similarity in the actions of the two users. A relatively negative event coordination score between two users indicates some degree of difference in the actions of the two users.

Take the calculation of the non-directional event coordination score between Michael and Pam as one example. Their initial non-directional event coordination score is 0. Then, as seen in FIG. 8A, Michael bought a gym membership while Pam did not. As a result, their non-directional event coordination score becomes −1. Neither Pam nor Michael bought a baseball jersey. Thus their score remains −1. Both Pam and Michael bought a bottle of rosé, and thus their score returns to 0. Pam bought a Labrador retriever while Michael did not, bringing their score back to −1. Finally, Michael bought hair gel, but Pam did not. Thus Pam and Michael's final non-directional event coordination score is −2 as seen in FIG. 8B. Again, because the order in which users perform events is not taken into account in FIG. 8A, both Pam and Michael receive the same event coordination score with regard to one another. This negative score indicates that Pam and Michael's actions are on average, negatively correlated. In other words, on average, with regard to the given events, Michael and Pam act differently than one another.

The same type of calculation is conducted for all pairs within the closed group of connections.

The method of calculating non-directional event coordination scores described in FIG. 8B is one embodiment of a method for the calculation of non-directional event coordination scores. Alternative embodiments not described here may also be used to calculate non-directional event coordination scores for a group of users.

FIG. 8C is a data chart of non-directional influence scores for a group of users, in accordance with an embodiment. Based on the non-directional event coordination scores of FIG. 8B, a non-directional influence score is calculated for each individual of the closed connection group. In the embodiment depicted in FIG. 8C, an individual's non-directional influence score is calculated by adding all of the given individual's non-directional event coordination scores with the other individuals of the connection group. Take Oscar as one example. As seen in FIG. 8B, Oscar's non-directional event coordination score with regard to Dwight is 1. Oscar's non-directional event coordination score with regard to Pam is 0. It is −1 with regard to Jim, and so on. By adding Oscar's non-directional event coordination scores with each individual of the closed connection group, he receives a final non-directional influence score of −3 as seen in FIG. 8C.

A non-directional influence score of relatively high value indicates that the given user has a relatively great influence over the actions of the other individuals in the closed group of connections. Conversely, a non-directional influence score of relatively low value indicates that the given user has relatively little influence over the actions of the other individuals in the closed group of connections. As seen in FIG. 8C, Dwight's influence score is the greatest at a value of 8. Thus Dwight is the most influential individual among the closed group of connections. Pam's influence score is the lowest at a value of −4. Thus Pam is the least influential individual among the closed group of connections.

An advertiser may use these influence scores to determine which individuals are the most influential with regard to their group of connections. These influential individuals may then be targeted with a given advertisement in the hope that if they engage with the advertisement, their connections may also be influenced to engage with the advertisement, even if the connections themselves have not seen the ad. In one embodiment, an advertiser may choose to advertise to all individuals with a non-directional influence score greater than a threshold value of 0. In this case, in the embodiment of FIG. 8C, only Dwight, Angela, and Meredith would be presented with the advertisement. As mentioned in regard to FIG. 3, alternative embodiments for the selection of influential subject users at whom to target advertisements are also possible though not explicitly described here.

FIGS. 9A, 9B, and 9C are meant to accompany one another and depict a method of directional influence score calculation for a group of users of the online system 104 in accordance with one embodiment. In other embodiments, directional influence score calculation may include different and/or additional steps than those shown in FIGS. 9A, 9B, and 9C. Additionally, steps of the method may be performed in different orders than the order described in conjunction with FIGS. 9A, 9B, and 9C in various embodiments.

FIGS. 9A, 9B, and 9C demonstrate the calculation of directional influence scores with regard to a group of users of the online system 104. These users of system 104 are Dwight, Pam, Jim, Michael, Angela, Oscar, and Meredith. In the embodiment shown in FIGS. 9A, 9B, and 9C, the group of users was not chosen with regard to a central subject user. Rather, the entire group was chosen as a whole with the intent of finding the user that has the greatest influence over all other users of the group. Thus for the purpose of influence score calculations, this group of users is assumed to be a closed connection group. In other words, the set of connections of each individual in the example group is assumed to comprise all of the other individuals within the group, and only those individuals. For example, Dwight's set of connections consists of Pam, Jim, Michael, Angela, Oscar, and Meredith. Angela's set of connections consists of Dwight, Pam, Jim, Michael, Oscar, and Meredith. This pattern continues for all other individuals within the group. As a result, each individual's influence score is calculated with respect to all of the non-self individuals in this single set of connections. Using these influence scores, the most influential individual in the group can be determined.

If this group was selected based on a single subject user and thus was not a closed connection group, only the subject user's influence score could be accurately calculated with regard to the given group. The influence scores of all other users within the group must be calculated with regard to each user's unique set of connections. In a majority of real world applications, connection groups are not closed. In other words, each subject user has a unique set of connections, and thus requires a unique set of connections. However, in some instances, it may be more desirable to find the most influential individual within a set group of individuals as in FIGS. 9A, 9B, and 9C. For example, a company selling cheese might want to find the most influential member within a local cheese lovers club.

FIG. 9A is a data chart indicating the order of event occurrence within the closed connection group mentioned above, in accordance with an embodiment. FIG. 9A lists five unique purchase opportunities. Specifically, each user has the opportunity to purchase or refuse the following items: a gym membership, a baseball jersey, a bottle of rosé, a Labrador retriever, and hair gel. In alternative embodiments, as described with regard to FIG. 3, alternative options may be used in the calculation of influence scores. The time at which each individual in the group decides to purchase each of these five items is considered an action or an event.

The data chart in FIG. 9A indicates the order in which individuals purchase each of the five items. A dash indicates that the corresponding user did not purchase the corresponding item. A number indicates that the corresponding user did purchase the corresponding item. Furthermore, the specific number indicates the order in which the corresponding user purchased the corresponding item relative to all other users that purchased the item. A ‘1’ indicates that the corresponding user was the last individual to purchase the corresponding item. A ‘2’ indicates that the corresponding user was the second to last individual to purchase the corresponding item, and so on. Thus the user with the largest number corresponding to a given item indicates that the user was the first to purchase the given item.

Take the hair gel purchase opportunity as an example. As seen in FIG. 9A, neither Pam, nor Jim, nor Angela purchased hair gel as indicated by the dash marks corresponding to these individuals. The highest number is a ‘4’ corresponding to Oscar. This indicates that Oscar was the first individual in the group to purchase the hair gel. Michael is assigned a value of ‘3’, indicating he was the second individual to purchase the hair gel. Finally, Meredith was the third to purchase the hair gel, and Dwight was the last individual to purchase the hair gel.

The quantitative data of FIG. 9A indicates an order in which events occurred. As a result, directional event coordination scores and thus directional influence scores can be calculated from this data as shown in FIGS. 9B and 9C.

FIG. 9B is a data chart of directional event coordination scores for the closed connection group of FIG. 9A, in accordance with an embodiment. Using the data describing the order of event occurrence in FIG. 9A, a unique directional event coordination score is calculated for each individual in the closed connection group, with respect to each additional individual in the closed connection group. For example, Dwight receives a unique directional event coordination score with regard to Pam and Pam receives a separate, unique directional event coordination score with regard to Dwight. This inclusion of directionality within the event coordination scoring more accurately demonstrates which individuals are the followers and which are the influencers.

In the embodiment depicted in FIG. 9B, the following standards are used to calculate a directional event coordination score for a user A with regard to a user B. The initial event coordination score for user A with regard to user B is set to a value of 0, indicating no event coordination. For each purchase event listed, the actions of users A and B are compared. If both users A and B did purchase the same item and user A purchased the given item prior to user B, one point is added to the event coordination score for user A with regard to user B. On the other hand, if both users A and B did purchase the same item but user A purchased the given item after user B, the event coordination score is unaffected. If one user purchased the item, but the other user did not purchase the item, one point is subtracted from their event coordination score. If both users A and B did not purchase the item, their event coordination score is unaffected.

A relatively positive event coordination score for user A with regard to user B indicates that overall, user A influenced the actions of user B. A relatively negative event coordination score for user A with regard to user B indicates that overall, user A had no influence over the actions of user B. The event coordination score for user A with regard to user B only indicates the degree to which user A prompted user B to act similarly. It does not indicate the impact that the actions of user B had on the actions of user A. Unlike the process described with regard to the non-directional event coordination scoring of FIG. 8B, user B does not automatically receive the same event coordination score as user A. Rather, a separate unique directional event coordination score for user B with regard to user A must also be calculated.

Take the calculation of the directional event coordination score for Pam with regard to Michael as one example. Pam's initial directional event coordination score with regard to Michael is 0. Then, as seen in FIG. 9A, Michael bought a gym membership while Pam did not. As a result, Pam's directional event coordination score with regard to Michael becomes −1. Neither Pam nor Michael bought a baseball jersey. Thus her score remains −1. Both Pam and Michael bought a bottle of rosé, and because Pam bought the bottle of rosé before Michael, and Pam's score with regard to Michael returns to 0. Pam bought a Labrador retriever while Michael did not, bringing her score back to −1. Finally, Michael bought hair gel, but Pam did not. Thus Pam's final directional event coordination score with regard to Michael is −2 as seen in FIG. 9B. This negative score indicates that Pam has relative little impact on Michael's actions. In other words, on average, with regard to the given events, Michael does not follow Pam.

Again, because the order in which users perform events is taken into account in FIG. 9A, Michael will receive a different event coordination score with regard to Pam. As seen in FIG. 9B, Michael's directional event coordination score with regard to Pam is −3. This indicates that Michael has even less influence over Pam than Pam does over Michael. The same type of calculation is conducted for all pairs within the closed group of connections.

The method of calculating directional event coordination scores described in FIG. 9B is one embodiment of a method for the calculation of directional event coordination scores. Alternative embodiments not described here may also be used to calculate directional event coordination scores for a group of users.

FIG. 9C is a data chart of directional influence scores for a group of users, in accordance with an embodiment. Based on the directional event coordination scores of FIG. 9B, a directional influence score is calculated for each individual of the closed connection group. In the embodiment depicted in FIG. 9C, an individual's directional influence score is calculated by adding all of the given individual's directional event coordination scores with regard to each other individual of the connection group. Take Oscar as one example. As seen in FIG. 9B, Oscar's directional event coordination score with regard to Dwight is 0. Oscar's directional event coordination score with regard to Pam is −3. It is −3 with regard to Jim, and so on. By adding Oscar's directional event coordination scores with regard to each individual of the closed connection group, he receives a final directional influence score of −6 as seen in FIG. 9C.

A directional influence score of relatively high value indicates that the given user has a relatively great influence over the actions of the other individuals in the closed group of connections. Conversely, a directional influence score of relatively low value indicates that the given user has relatively little influence over the actions of the other individuals in the closed group of connections. As seen in FIG. 9C, Dwight's influence score is the greatest at a value of −3. Thus Dwight is the most influential individual among the closed group of connections. Angela's influence score is the lowest at a value of −10. Thus Angela is the least influential individual among the closed group of connections.

An advertiser may use these influence scores to determine which individuals are the most influential with regard to their group of connections. These influential individuals may then be targeted with a given advertisement in the hope that if they engage with the advertisement, their connections may also be influenced to engage with the advertisement, even if the connections themselves have not seen the ad. In one embodiment, an advertiser may choose to advertise to all individuals with a directional influence score greater than a threshold value of −6. In this case, in the embodiment of FIG. 9C, only Dwight, Pam, and Meredith would be presented with the advertisement. As mentioned in regard to FIG. 3, alternative embodiments for the selection of influential subject users at whom to target advertisements are also possible though not explicitly described here.

By accounting for directionality of influence, the most influential members of the group may change. For example, without accounting for directionality, as shown in FIG. 8B, Pam received the lowest non-directional influence score and was thus considered the least influential. However, by accounting for directionality, as shown in FIG. 9B, not only did Pam not receive the lowest directional influence score; she received the second greatest directional influence score. Thus by accounting for directionality, Pam was deemed as the second most influential individual of the group. A similar situation occurred with regard to Angela. Without accounting for directionality, Angela received one of the greatest non-directional influence scores and was included in the list of individuals that were deemed influential enough to be presented with an advertisement. However, when accounting for directionality, Angela received the lowest directional influence score. Thus by accounting for directionality, Angela was deemed the least influential individual of the group, and would be the last to be presented with an advertisement. This large discrepancy in influence scores demonstrates the importance of using directional influence scoring when attempting to accurately identify the most influential individuals at whom to target an advertisement.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method for selecting users of an online system to present content items to, the method comprising:
receiving targeting criteria for a campaign of a content item, the targeting criteria specifying targeting criteria for selecting users of the online system to present with the content item;
identifying a subject user meeting the targeting criteria;
identifying a set of connections of the subject user also meeting the targeting criteria;
determining, based on the targeting criteria, an event coordination score between the subject user and each connection in the set of connections, an event coordination score being determined by a comparison of one or more events co-occurring for the subject user and the connection;
determining, from the event coordination scores, an influence score for the subject user;
presenting the content item to the subject user based in part on the influence score.

2. The method of claim 1, wherein the received targeting criteria specify characteristics of the one or more subject users.

3. The method of claim 1, wherein the received targeting criteria specify characteristics of the set of connections of the one or more subject users.

4. The method of claim 1, wherein the received targeting criteria specify criteria for calculating the event coordination scores.

5. The method of claim 1, wherein the event coordination scores are determined by calculating a cosine similarity between a first set of events performed by the subject user and a second set of events performed by the connection of the set of connections.

6. The method of claim 1, wherein the one or more events used in the determination of the event coordination scores is purchase information for one or more items.

7. The method of claim 1, wherein the one or more events used in the determination of the event coordination scores is interaction with one or more content items.

8. The method of claim 1, wherein the one or more events used in the determination of the event coordination scores is social behaviors performed on the online system by the subject user and the connection.

9. The method of claim 1, wherein an order of the occurrence of the one or more events associated with the subject user and the connection is used in the determining of the event coordination score.

10. The method of claim 1, wherein the content item is presented to the subject user if the influence score for the subject user is at least a threshold influence score.

11. The method of claim 1, wherein the content item is presented to the subject user if an expected value of presenting the content item to the subject user is greater than a threshold expected value.

12. The method of claim 11, wherein the expected value of presenting the content item to the subject user is based in part on a bid amount associated with the campaign of the content item.

13. A non-transitory computer-readable medium having instructions for execution by a processor causing the processor to:
receive targeting criteria for a campaign of a content item, the targeting criteria specifying targeting criteria for selecting users of the online system to present with the content item;
identify a subject user meeting the targeting criteria;
identify a set of connections of the subject user also meeting the targeting criteria;
determine, based on the targeting criteria, an event coordination score between the subject user and each connection in the set of connections, an event coordination score being determined by a comparison of one or more events co-occurring for the subject user and the connection;
determine, from the event coordination scores, an influence score for the subject user;
present the content item to the subject user based in part on the influence score.

14. The non-transitory computer-readable medium of claim 13, wherein the received targeting criteria specify characteristics of the one or more subject users.

15. The non-transitory computer-readable medium of claim 13, wherein the received targeting criteria specify characteristics of the set of connections of the one or more subject users.

16. The non-transitory computer-readable medium of claim 13, wherein the received targeting criteria specify criteria for calculating the event coordination scores.

17. The non-transitory computer-readable medium of claim 13, wherein the event coordination scores are determined by calculating a cosine similarity between a first set of events performed by the subject user and a second set of events performed by the connection of the set of connections.

18. The non-transitory computer-readable medium of claim 13, wherein the one or more events used in the determination of the event coordination scores is purchase information for one or more items.

19. The non-transitory computer-readable medium of claim 13, wherein the one or more events used in the determination of the event coordination scores is interaction with one or more content items.

20. The non-transitory computer-readable medium of claim 13, wherein the one or more events used in the determination of the event coordination scores is social behaviors performed on the online system by the subject user and the connection.

21. The non-transitory computer-readable medium of claim 13, wherein an order of the occurrence of the one or more events associated with the subject user and the connection is used in the determining of the event coordination score.

22. The non-transitory computer-readable medium of claim 13, wherein the content item is presented to the subject user if the influence score for the subject user is at least a threshold influence score.

23. The non-transitory computer-readable medium of claim 13, wherein the content item is presented to the subject user if an expected value of presenting the content item to the subject user is greater than a threshold expected value.

24. The non-transitory computer-readable medium of claim 22, wherein the expected value of presenting the content item to the subject user is based in part on a bid amount associated with the campaign of the content item.
